(19) United States
(12) Patent Application Publication
(10) Pub. No.: US 2004/0193931 A1
(43) Pub. Date: Sep. 30, 2004

(54) System and method for transferring data from a first clock domain to a second clock domain

(76) Inventors: Ryan L. Akkerman, Allen, TX (US); Richard W. Adkisson, Dallas, TX (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/397,555

(22) Filed: Mar. 26, 2003

(51) Int. Cl. G06F 1/12

(52) U.S. Cl. 713/400

(57) ABSTRACT

A system and method using a synchronizer circuit for effectuating data transfer across a clock domain boundary between a first clock domain and a second clock domain, wherein the first clock domain is operable with a first clock signal and the second clock domain is operable with a second clock signal. The first and second clock signals have a ratio of N first clock cycles to (N-1) second clock cycles. A first circuit portion operates to transfer (N-1) data bits, based on which clock cycle of the first clock signal has an extra data bit, out of N data bits across the clock boundary on a first data path of the synchronizer output. A second circuit portion operates to transfer the remaining extra data bit on a second data path of the synchronizer's output.

### CROSS-REFERENCE TO RELATED APPLICATION(S)

This application discloses subject matter related to the subject matter disclosed in the following commonly owned co-pending patent application(s): (i) “System And Method For Transferring Data From A Higher Frequency Clock Domain To A Lower Frequency Clock Domain,” filed Aug. 23, 2001, Ser. No. 09/938,206, in the name(s) of: Rajakrishnan Radjassamy.

### BACKGROUND

Digital electronic systems, e.g., computer systems, often need to communicate using different interfaces, each running at an optimized speed for increased performance. Typically, multiple clock signals having different frequencies are utilized for providing appropriate timing to the interfaces. Further, the frequencies of such clock signals are generally related to one another in a predetermined manner. For example, a core or system clock running at a particular frequency (F_{C}) may be utilized as a master clock in a typical computer system for providing a time base with respect to a specific portion of its digital circuitry. Other portions of the computer system's digital circuitry (such as a bus segment and the logic circuitry disposed thereon) may be clocked using timing signals derived from the master clock wherein the derived frequencies (F_{D}) follow the relationship: F_{C}/F_{D}≧1.

Because of the asynchronous-although related-nature of the constituent digital circuit portions, synchronizer circuitry is often used in computer systems to synchronize data transfer operations across a clock domain boundary so as to avoid timing-related data errors. Such synchronizer circuitry is typically required to possess low latency (which necessitates precise control of the asynchronous clocks that respectively clock the circuit portions in two different clock domains). Furthermore, since phase-locked loops (PLLs) utilized in conventional arrangements to produce clocks of different yet related frequencies can have a large amount of input/output (I/O) jitter, it is essential that the synchronizer circuitry be able to tolerate significant amounts of low frequency phase difference (or, skew) between the clocks generated thereby. Although conventional synchronizer circuitry arrangements have been generally adequate in addressing these issues, several other shortcomings persist. Most significantly, for instance, where data transfer is to be effectuated from a fast clock domain (i.e., with higher frequency) to a slow clock domain (i.e., with lower frequency), the possibility of one or more “dead ticks” remains, which necessitates delaying of one or more incoming data bits. Not only does this solution give rise to reduced data transfer rates, but it is simply ineffectual in applications that cannot tolerate any delay in the incoming data.

### SUMMARY

A system and method using a synchronizer circuit are described for effectuating data transfer across a clock domain boundary between a first clock domain and a second clock domain, wherein the first clock domain is operable with a first clock signal and the second clock domain is operable with a second clock signal. The first and second clock signals have a ratio of N first clock cycles to (N-1) second clock cycles. In one embodiment, a first circuit portion operates to transfer (N-1) data bits, based on which clock cycle of the first clock signal has an extra data bit, out of N data bits across the clock boundary on a first data path of the synchronizer output. A second circuit portion operates to transfer the remaining extra data bit on a second data path of the synchronizer's output.

### BRIEF DESCRIPTION OF THE DRAWINGS

FIG. 1 depicts a timing sequence of two clock domains having a 5:4 frequency ratio wherein data transfer across the clock boundary using a conventional synchronizer results in an extra data cycle in which data cannot be transferred;

FIG. 2 depicts a block diagram of one embodiment of a synchronizer circuit of the present invention operable to transfer data at full bandwidth across a clock boundary between clock domains having a frequency ratio of N fast clock cycles to (N-1) slow clock cycles;

FIG. 3 depicts a timing drawing of the various signals associated with a 5:4 synchronizer circuit for effectuating data transfer without a dead tick wherein four data bits are transferred on one output data path and the remaining extra data bit is transferred on a second output data path;

FIGS. 4A-4C depict a plurality of timing drawing panels relating to a 4:3 synchronizer circuit wherein different extra data bits are clocked out; and

FIG. 5 depicts a flow chart of the operations involved in one embodiment of the method of the present invention for transferring data across a clock boundary at full bandwidth.

### DETAILED DESCRIPTION OF THE DRAWINGS

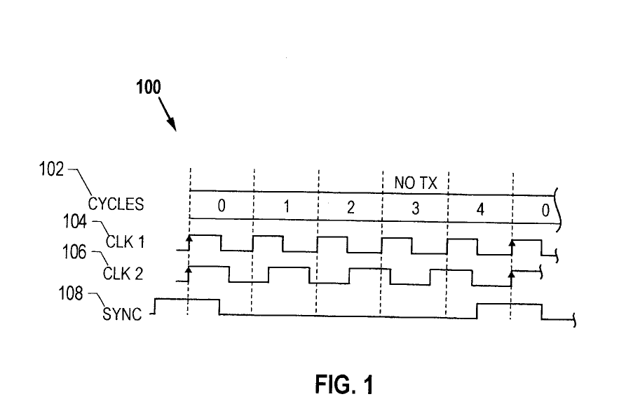

In the drawings, like or similar elements are designated with identical reference numerals throughout the several views thereof, and the various elements depicted are not necessarily drawn to scale. Referring now to FIG. 1, depicted therein is a timing sequence 100 of two clock domains having a 5:4 frequency ratio wherein data transfer across the clock boundary using a conventional synchronizer results in an extra data cycle in which data cannot be transferred. As is well known, data transfer operations between circuitry of a first clock domain and circuitry of a second clock domain are effectuated by synchronizer circuitry disposed therebetween. Further, the first and second clock domains are operable with clock signals that have a particular cycle ratio. For instance, the circuitry of the first clock domain (“fast clock domain”) may be clocked with a first clock signal (CLK1) that is faster than a second clock signal (CLK2) used for clocking the circuitry of the second clock domain (“slow clock domain”) such that there are N first clock cycles to (N-1) second clock cycles. In one application, core clock circuitry and bus clock circuitry of a computer system may represent the first and second clock domains, respectively, wherein CLK1 and CLK2 signals correspond to the core clock (CC) and bus clock (BC) signals.

A synchronizer controller circuit (not shown in FIG. 1) is usually provided for controlling the operation of synchronizer circuitry disposed between the two clock domains. Additionally, a control signal such as a SYNC pulse may be generated based on a predetermined temporal relationship between CLK1 and CLK2 for synchronizing the data transfer operations. For example, the SYNC pulse may be generated when a rising edge of the CLK1 signal coincides with a rising edge of the CLK2 signal, which commences a data transmit window for the transfer of data bits from one clock domain to the other clock domain.

The timing sequence 100 of FIG. 1 illustrates an embodiment of CLK1 104, CLK2 106 and SYNC pulse signal 108, wherein for every five ticks of CLK1 there are four ticks of the slow clock (i.e., CLK2). A cycle count 102 refers to the numbering of CLK1 cycles in a particular data transmit window of the timing sequence 100. Data to be transferred from the fast clock domain is clocked at CLK1, that is, 5 data pulses per window are available.

As alluded to before, the SYNC pulse 108 is high on coincident rising edges of CLK1 and CLK2 and the data transfer operations across the clock boundary between the two clock domains are timed with reference to the SYNC pulse. In a normal condition where there is no skew (or, jitter, as it is sometimes referred to) between CLK1 and CLK2, the coincident edges occur on the rising edges of the first cycle (cycle 0) as shown in FIG. 1. Since there are five CLK1 cycles and only four CLK2 cycles, CLK1 domain circuit portion cannot transmit data during one cycle resulting in what is known as a “dead tick,” as CLK2 domain circuit portion does not have a corresponding time slot for receiving it. Typically, the cycle that is least skew tolerant is the one where data is not transmitted and, in the exemplary timing sequence shown in FIG. 1, it is the fourth cycle (i.e., cycle 3).

Skew between CLK1 and CLK2 signals can cause, for example, a variance in the positioning of the SYNC pulse which affects the data transfer operations between CLK1 and CLK2 domains. In the exemplary 5:4 frequency ratio scenario set forth above, if CLK2 leads CLK1 by a quarter cycle for instance, then instead of the edges being coincident at the start of cycle 0, they will be coincident at the start of cycle 1 and the dead tick's location may accordingly vary. In similar fashion, if CLK2 lags CLK1 by a quarter cycle, the edges will be coincident at the start of the last cycle (i.e., cycle 4). Regardless of the skew between the clock cycles, however, there will be a cycle where a data bit cannot be sent, resulting in data transfer at less than full bandwidth. Further, as pointed out in the Background of the present patent application, in applications where the incoming data cannot be slowed down, the conventional synchronizer scheme simply does not work.

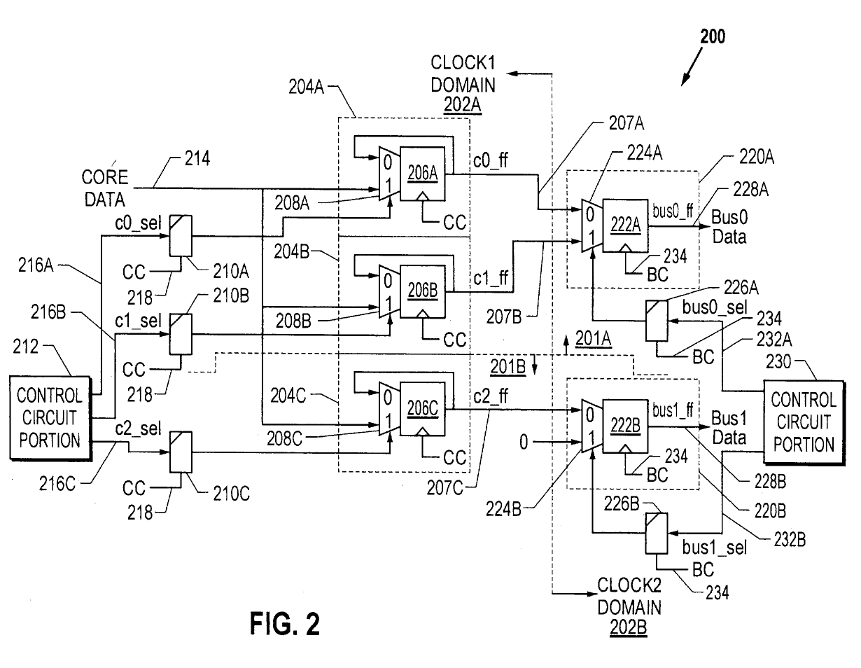

FIG. 2 depicts a block diagram of one embodiment of a synchronizer circuit 200 of the present invention operable to transfer data at full bandwidth across a clock boundary between clock domains having a frequency ratio of N fast clock cycles to (N-1) slow clock cycles. Reference numerals 202A and 202B refer to two representative clock domains such as system/core clock circuitry and bus clock circuitry of a computer system that are clocked by a core clock (CC) signal 218 and a bus clock (BC) signal 234, respectively. Incoming data, i.e., core data, is provided on an incoming data path 214 at full bandwidth (i.e., N data pulses or bits in a timing cycle window) for transport across the boundary to the bus clock domain 202B. Essentially, from an overall system-level functionality perspective, the synchronizer circuit 200 operates as having a first circuit portion 201A responsible for transferring (N-1) data bits across the boundary on a first output data path 228A disposed in the bus clock domain and a second circuit portion 201B responsible for transferring the remaining extra data bit across the boundary on a second output data path 228B disposed therein.

In the circuit embodiment shown in FIG. 2, the first circuit portion 201B for transferring (N-1) data bits comprises a first TRANSMIT multiplexer-register (MUXREG) block 204A that includes a 2:1 MUX 208A coupled to at least one flip-flop-based register 206A and a second TRANSMIT multiplexer-register (MUXREG) block 204B that also includes, in turn, a 2:1 MUX 208B coupled to at least one flip-flop-based register 206B. The flip-flops of the fast clock MUXREG blocks 204A and 204B are clocked by the first clock signal, i.e., the CC signal 218, for serially transmitting data bits on outputs c0_ff 207A and c1_ff 207B that are connected to a first RECEIVE MUXREG block 220A that includes a 2:1 MUX 224A and FF portion 222A. As will be seen in additional detail hereinbelow with reference to an exemplary timing sequence, the c0_ff path 207A is operable to transmit a first portion of the (N-1) data bits and c1_ff path 207B is operable to transport the remaining portion of (N-1) data bits.

Each of the 2:1 MUX elements of first and second TRANSMIT MUXREG blocks 204A and 204B receives the core data at its logic high input. The other input (logic low input) receives the respective FF output (i.e., c0_ff or c1_ff output) in a feedback loop. Further, the 2:1 MUXes 208A and 208B are controlled by respective fast clock control signals c0_sel 216A and c1_sel 216B that are first registered using registers 210A and 210B operating in the core clock domain 202A. A synchronizer controller circuit portion 212 may be provided for generating appropriate control signals such as the control signals c0_sel 216A and c1_sel 216B. In addition, a data transfer validation signal such as core-to-bus valid (c2b_valid) signal (not shown) may also be supplied to the synchronizer circuitry for properly clocking out the data bits on data paths disposed in the bus clock domain.

As pointed out previously, the outputs c0_ff 207A and c1_ff 207B of the two TRANSMIT MUXREG blocks are provided to the RECEIVE MUXREG block 220A such that the logic high and logic low inputs its 2:1 MUX 224A are respectively coupled to c1_ff 207B and c0_ff 207A. A first slow clock control bus0_sel 232A is registered with a register 226A before being applied to the 2:1 MUX 224A. The two data portions of the (N-1) bits are thus multiplexed and clocked out via the FF element 222A whose output bus0_ff is provided on data path 228A as BusO DATA. As with the control signals in the core clock domain 202A, a synchronizer controller circuit portion 230 may be provided for generating appropriate control signals such as bus0_sel 232A. Of course, it should be apparent that the two synchronizer controller circuit portions 212 and 230 may be integrated into a single controller circuit in any fashion.

Similar to the circuitry described above, the second circuit portion 201B of the synchronizer circuit 200 for transferring the remaining extra data bit on a separate data path is comprised of a third TRANSMIT MUXREG block 204C that receives core data pulses on the incoming data path 214 and clocks out the extra data bit responsive to another fast clock control signal (c2_sel 216C) that is registered using register 210C in the core clock domain. A second RECEIVE MUXREG block 220B receives the extra data bit on c2_ff path 207C coupled to the logic low input of its 2:1 MUX 224B. Since there is no other data to be multiplexed, the logic high input of the 2:1 MUX 224B is tied to zero. A second slow clock control signal generated by the controller circuit portion 230, bus1_sel 232B, is first registered using a register 226B before being applied to the 2:1 MUX 224B. The data output of the FF element 222B of the MUXREG block 220B, i.e., bus1_ff, includes the extra data bit and is clocked out on the second data path 228B as Bus1 DATA.

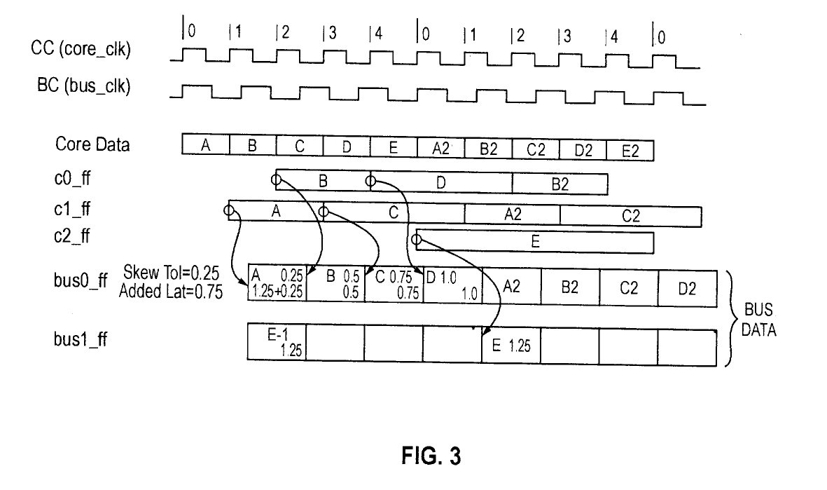

FIG. 3 depicts a timing drawing of the various signals associated with a 5:4 synchronizer circuit for effectuating data transfer without a dead tick wherein four data bits A, B, C and D, are transferred on one output data path (as bus0_ff) and the remaining extra data bit (E) is transferred on a second output data path as bus1_ff. As can be readily seen, there are four BC cycles for every five CC cycles, with the core data being bits A through E. Although each incoming data bit takes up only one CC cycle, the data on the outputs of TRANSMIT MUXREG blocks can take up more than a cycle, i.e., stretched out. For example, the c0_ff output comprises bits B and D that are two and three cycle-wide, respectively. Likewise, the c1_ff output comprises bits A and C where A is valid for two CC cycles and C is valid for three CC cycles. The c2_ff output comprises the data bit E that is stretched out for five CC cycles. Depending on the occurrence of c2b_valid control signal (not shown), data bits A through D are clocked out on bus0_ff output and data bit E on bus1_ff, which together make up the full 5-bit bus clock data.

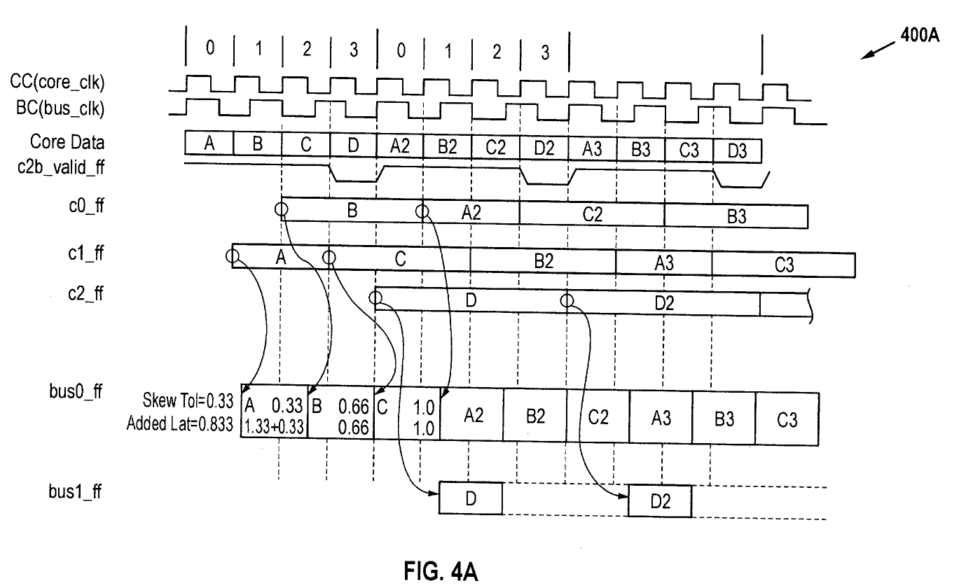

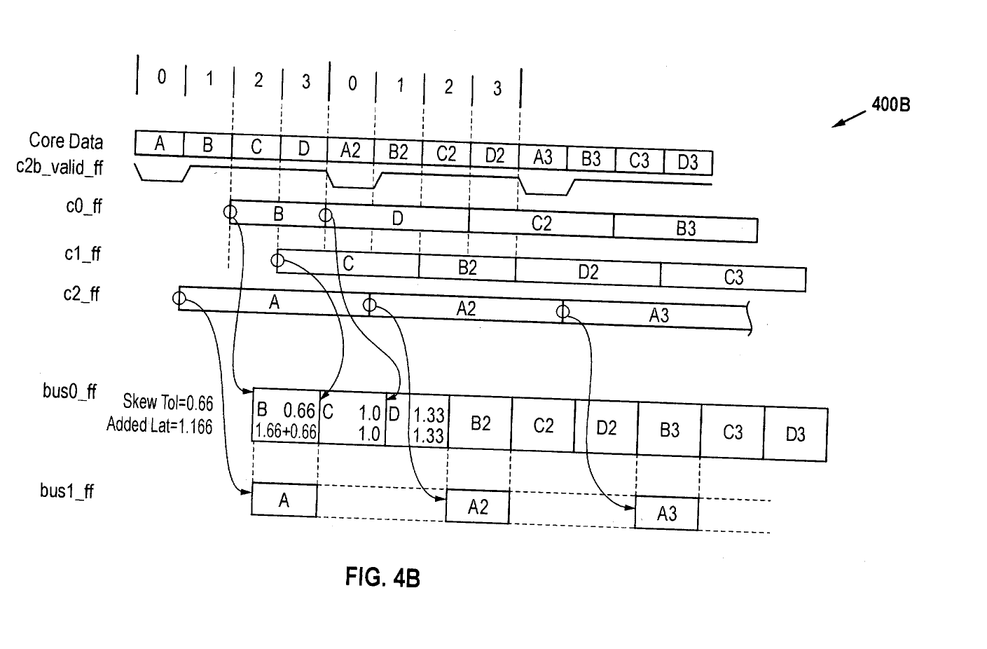

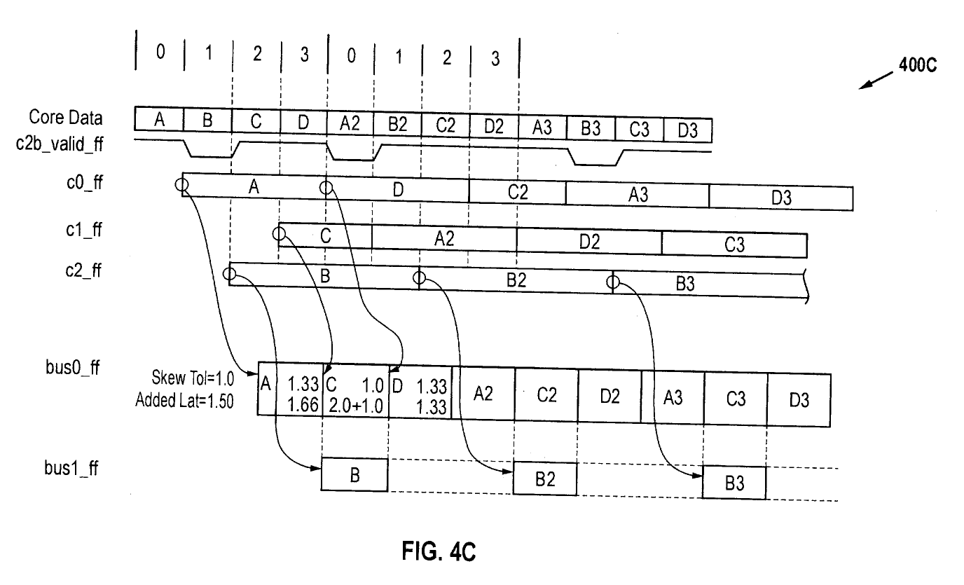

Referring now to FIGS. 4A-4C, a plurality of timing drawing panels relating to a 4:3 synchronizer circuit are shown wherein different extra data bits are clocked out depending on the amount of clock skew and latency. Since skew tolerance can be programmably determined by the synchronizer circuitry, the full bandwidth of the incoming core data can be “split” into variable portions, the (N-1) data bits going out on one output path and the extra bit going out on a second output path. In the timing drawing panel 400A shown in FIG. 4A, skew tolerance and latency are set to 0.33 and 0.833, respectively, and the extra data bit is determined to be bit D. Accordingly, data bits A-C are transferred on bus0_ff while data bit D is transferred on bus1_ff. In the timing drawing panel 400B of FIG. 4B, skew tolerance and latency are set to 0.66 and 1.166. Data bit A, the extra data bit, goes out on bus1_ff whereas bits B-D are transmitted on bus0_ff. Finally, the timing drawing panel 400C shown in FIG. 4C illustrates the condition of increased skew tolerance and latency parameters where data bit B is clocked out the secondary output data path.

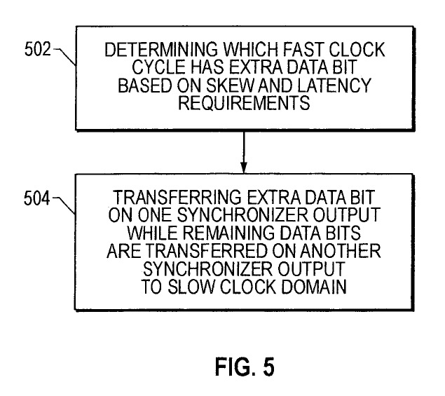

FIG. 5 depicts a flow chart of the operations involved in one embodiment of the method of the present invention for transferring data across a clock boundary at full bandwidth. Based on skew and latency requirements of the ratioed synchronizer circuitry described above, which in turn depend on the particular data transfer application and associated clock frequencies and their cycle ratio, it is determined as to which fast clock cycle has a dead tick, i.e., extra data bit (block 502). As set forth in detail in the foregoing discussion, the extra data bit is transferred on one synchronizer output while the remaining (N-1) data bits are transferred on the other output of the synchronizer circuitry. Thus, the need for having to delay one data pulse on the incoming data is obviated, whereby data transfer at maximum bandwidth is achieved between the two clock domains.

Although the invention has been described with reference to certain illustrations, it is to be understood that the forms of the invention shown and described are to be treated as exemplary embodiments only. Accordingly, various changes, substitutions and modifications can be realized therein without departing from the spirit and scope of the invention as defined by the appended claims.

What is claimed is:

1. A synchronizer circuit for effectuating data transfer across a clock boundary between a first clock domain and a second clock domain, wherein said first clock domain is operable with a first clock signal and said second clock domain is operable with a second clock signal, said first and second clock signals having a ratio of N first clock cycles to (N-1) second clock cycles, comprising:
a first circuit portion for transferring (N-1) data bits across said clock boundary on a first data path disposed in said second clock domain, wherein said data bits are generated in said first clock domain clocked with said first clock signal having N clock cycles; and
a second circuit portion for transferring a remaining extra data bit across said clock boundary on a second data path disposed in said second clock domain.

2. The synchronizer circuit for effectuating data transfer across a clock boundary between a first clock domain and a second clock domain as set forth in claim 1, wherein said first circuit portion comprises:
a first TRANSMIT multiplex-register (MUXREG) block disposed in said first clock domain, said first MUXREG block operating to transmit a portion of said (N-1) data bits in a serial fashion responsive to a first fast clock control signal that is registered using said first clock signal;
a second TRANSMIT MUXREG block in said first clock domain for transmitting remaining portion of said (N-1) data bits in a serial fashion responsive to a second fast clock control signal that is registered using said first clock signal; and
a first RECEIVE MUXREG block disposed in said second clock domain for receiving said (N-1) data bits from said first and second TRANSMIT MUXREG blocks in a serial fashion responsive to a first slow clock control signal that is registered using said second clock signal, wherein said (N-1) data bits are clocked out from said first RECEIVE MUXREG on said first data path using said second clock signal.

3. The synchronizer circuit for effectuating data transfer across a clock boundary between a first clock domain and a second clock domain as set forth in claim 2, wherein said second circuit portion comprises:
a third TRANSMIT MUXREG block disposed in said first clock domain for transmitting said remaining extra data bit responsive to a third fast clock control signal that is registered using said first clock signal; and
a second RECEIVE MUXREG block disposed in said second clock domain for receiving said remaining extra data bit from said third TRANSMIT MUXREG block in a serial fashion responsive to a second slow clock control signal that is registered using said second clock signal, wherein said remaining extra data bit is clocked out from said second RECEIVE MUXREG on said second data path using said second clock signal.

4. The synchronizer circuit for effectuating data transfer across a clock boundary between a first clock domain and a second clock domain as set forth in claim 3, wherein occurrence of said remaining extra data bit is based on skew between said first and second clock signals.

5. The synchronizer circuit for effectuating data transfer across a clock boundary between a first clock domain and a second clock domain as set forth in claim 3, wherein said first, second and third fast clock control signals are generated by a first synchronizer controller portion.

6. The synchronizer circuit for effectuating data transfer across a clock boundary between a first clock domain and a second clock domain as set forth in claim 5, wherein said first and second slow clock control signals are generated by a second synchronizer controller portion.

7. The synchronizer circuit for effectuating data transfer across a clock boundary between a first clock domain and a second clock domain as set forth in claim 6, wherein said first and second synchronizer controller portions are integrated into a single controller circuit.

8. The synchronizer circuit for effectuating data transfer across a clock boundary between a first clock domain and a second clock domain as set forth in claim 6, wherein each of said first, second and third TRANSMIT MUXREG blocks comprises a 2:1 multiplexer coupled to a flip-flop.

9. The synchronizer circuit for effectuating data transfer across a clock boundary between a first clock domain and a second clock domain as set forth in claim 8, wherein a first input of said 2:1 multiplexer is coupled to an incoming data path carrying said data bits in said first clock domain and a second input of said 2:1 multiplexer is coupled to said flip-flop's output via a feedback loop.

10. The synchronizer circuit for effectuating data transfer across a clock boundary between a first clock domain and a second clock domain as set forth in claim 9, wherein said first input of said 2:1 multiplexer is selected when a fast clock control signal associated therewith is driven HIGH.

11. The synchronizer circuit for effectuating data transfer across a clock boundary between a first clock domain and a second clock domain as set forth in claim 9, wherein said 2:1 multiplexer is controlled by one of said first, second and third fast clock control signals.

12. The synchronizer circuit for effectuating data transfer across a clock boundary between a first clock domain and a second clock domain as set forth in claim 9, wherein said flip-flop's output from each of said first and second TRANSMIT MUXREG blocks is provided to said first RECEIVE MUXREG block and said flip-flop's output from said third TRANSMIT MUXREG block is provided to said second RECEIVE MUXREG block.

13. The synchronizer circuit for effectuating data transfer across a clock boundary between a first clock domain and a second clock domain as set forth in claim 12, wherein each of said first and second RECEIVE MUXREG blocks includes a 2:1 multiplexer coupled to a flip-flop that is clocked with said second clock signal.

14. The synchronizer circuit for effectuating data transfer across a clock boundary between a first clock domain and a second clock domain as set forth in claim 13, wherein said 2:1 multiplexer of said first and second RECEIVE MUXREG blocks is controlled by one of said first and second slow clock control signals.

15. The synchronizer circuit for effectuating data transfer across a clock boundary between a first clock domain and a second clock domain as set forth in claim 13, wherein output from said flip-flop of said first RECEIVE MUXREG block is provided to said first data path and output from said flip-flop of said second RECEIVE MUXREG block is provided to said second data path.

16. A method of effectuating data transfer across a clock boundary between a first clock domain and a second clock domain, wherein said first clock domain is operable with a first clock signal and said second clock domain is operable with a second clock signal, said first and second clock signals having a ratio of N first clock cycles to (N-1) second clock cycles, comprising:
based on which clock cycle of said first clock signal has an extra data bit, transferring (N-1) out of N data bits across said clock boundary on a first data path of a synchronizer output, wherein said data bits are generated in said first clock domain clocked with said first clock signal having N clock cycles; and
transferring said extra data bit across said clock boundary on a second data path of said synchronizer output, wherein said first and second data paths are disposed in said second clock domain.

17. The method of effectuating data transfer across a clock boundary between a first clock domain and a second clock domain as set forth in claim 16, wherein occurrence of said extra data bit is based on skew between said first and second clock signals.

18. The method of effectuating data transfer across a clock boundary between a first clock domain and a second clock domain as set forth in claim 16, wherein a first portion of said (N-1) data bits are transferred serially via a first TRANSMIT multiplex-register (MUXREG) block coupled to a first RECEIVE MUXREG block disposed in said second clock domain.

19. The method of effectuating data transfer across a clock boundary between a first clock domain and a second clock domain as set forth in claim 18, wherein a second portion of said (N-1) data bits are transferred serially via a second TRANSMIT multiplex-register (MUXREG) block coupled to said first RECEIVE MUXREG block disposed in said second clock domain.

20. The method of effectuating data transfer across a clock boundary between a first clock domain and a second clock domain as set forth in claim 19, wherein said extra data bit is transferred serially via a third TRANSMIT multiplex-register (MUXREG) block coupled to a second RECEIVE MUXREG block disposed in said second clock domain.

21. A computer system including circuitry for effectuating data transfer at full bandwidth across a clock boundary between a first clock domain (“fast clock domain”) and a second clock domain (“slow clock domain”) using a ratioed synchronizer, wherein said first clock domain is operable with a first clock signal and said second clock domain is operable with a second clock signal, said first and second clock signals having a ratio of N first clock cycles to (N-1) second clock cycles, comprising:
means for transferring, based on which clock cycle of said first clock signal has an extra data bit, (N-1) data bits out of N data bits across said clock boundary on a first data path of said synchronizer's output, wherein said data bits are generated in said first clock domain clocked with said first clock signal having N clock cycles; and
means for transferring said extra data bit across said clock boundary on a second data path of said synchronizer's output, wherein said first and second data paths are disposed in said second clock domain.

22. The computer system as set forth in claim 21, wherein said means for transferring said (N-1) data bits comprises:
a first TRANSMIT multiplex-register (MUXREG) block disposed in said first clock domain, said first MUXREG block operating to transmit a portion of said (N-1) data bits in a serial fashion responsive to a first fast clock control signal that is registered using said first clock signal;
a second TRANSMIT MUXREG block in said first clock domain for transmitting remaining portion of said (N-1) data bits in a serial fashion responsive to a second fast clock control signal that is registered using said first clock signal; and
a first RECEIVE MUXREG block disposed in said second clock domain for receiving said (N-1) data bits from said first and second TRANSMIT MUXREG blocks in a serial fashion responsive to a first slow clock control signal that is registered using said second clock signal, wherein said (N-1) data bits are clocked out from said first RECEIVE MUXREG block on said first data path using said second clock signal.

23. The computer system as set forth in claim 22, wherein said means for transferring said extra data bit comprises:
a third TRANSMIT MUXREG block disposed in said first clock domain for transmitting said remaining extra data bit responsive to a third fast clock control signal that is registered using said first clock signal; and
a second RECEIVE MUXREG block disposed in said second clock domain for receiving said remaining extra data bit from said third TRANSMIT MUXREG block in a serial fashion responsive to a second slow clock control signal that is registered using said second clock signal, wherein said remaining extra data bit is clocked out from said second RECEIVE MUXREG block on said second data path using said second clock signal.

24. The computer system as set forth in claim 23, wherein occurrence of said remaining extra data bit is based on skew between said first and second clock signals.

25. The computer system as set forth in claim 23, wherein said first, second and third fast clock control signals are generated by a first synchronizer controller portion.

26. The computer system as set forth in claim 25, wherein said first and second slow clock control signals are generated by a second synchronizer controller portion.

27. The computer system as set forth in claim 26, wherein said first and second synchronizer controller portions are integrated into a single controller circuit.

28. The computer system as set forth in claim 26, wherein each of said first, second and third TRANSMIT MUXREG blocks comprises a 2:1 multiplexer coupled to a flip-flop.

29. The computer system as set forth in claim 28, wherein a first input of said 2:1 multiplexer is coupled to an incoming data path carrying said data bits in said first clock domain and a second input of said 2:1 multiplexer is coupled to said flip-flop's output via feedback loop.

30. The computer system as set forth in claim 29, wherein said first input of said 2:1 multiplexer is selected when a fast clock control signal associated therewith is driven HIGH.

31. The computer system as set forth in claim 29, wherein said 2:1 multiplexer is controlled by one of said first, second and third fast clock control signals.

32. The computer system as set forth in claim 29, wherein said flip-flop's output from each of said first and second TRANSMIT MUXREG blocks is provided to said first RECEIVE MUXREG block and said flip-flop's output from said third TRANSMIT MUXREG block is provided to said second RECEIVE MUXREG block.

33. The computer system as set forth in claim 32, wherein each of said first and second RECEIVE MUXREG blocks includes a 2:1 multiplexer coupled to a flip-flop that is clocked with said second clock signal.

34. The computer system as set forth in claim 33, said 2:1 multiplexer of said first and second RECEIVE MUXREG blocks is controlled by one of said first and second slow clock control signals.

35. The computer system as set forth in claim 33, wherein output from said flip-flop of said first RECEIVE MUXREG block is provided to said first data path and output from said flip-flop of said second RECEIVE MUXREG block is provided to said second data path.
